(19) United States
(12) Patent Application Publication
(10) Pub. No.: US 2009/0102208 A1
(43) Pub. Date: Apr. 23, 2009

(54) BACK BEAM STRUCTURE FOR VEHICLE

(76) Inventor: Huensick Min, Suwon-si (KR)

Correspondence Address: MORGAN, LEWIS & BOCKIUS LLP (SF), One Market, Spear Street Tower, Suite 2800, San Francisco, CA, 94105, US

(21) Appl. No.: 11/959,713

(22) Filed: Dec. 19, 2007

(30) Foreign Application Priority Data
Oct. 17, 2007 (KR) 10-2007-0104377

(51) Int. Cl. B60R 19/02

(52) U.S. Cl. 293/102

(57) ABSTRACT

The present invention provides a back beam structure for a vehicle. The back beam structure for a vehicle includes extension parts formed at both distal end portions of a back beam. The back beam extends in a width direction of a vehicle and then is gently curved toward the front side of the vehicle. The extension parts are curved toward the rear side of the vehicle and then extend straightly. Accordingly, the back beam structure generates a repulsive force, which is generated at rounded corners of a vehicle, of a back beam against offset collision of the vehicle in a direction opposite to a collision direction, so that a supporting force of a bumper is improved. Further, the back beam structure allows the bumper not to slide on the back beam.

### CROSS-REFERENCE TO RELATED APPLICATIONS

The present application is based on, and claims priority from, Korean Application Serial Number 10-2007-0104377, filed on Oct. 17, 2007, the disclosure of which is hereby incorporated by reference herein in its entirety.

### FIELD OF THE INVENTION

The present invention relates to a back beam structure for a vehicle. More particularly, the present invention relates to a back beam structure for a vehicle including extension parts that are formed at both distal end portions of a back beam so as to be curved toward the rear side of a vehicle, thereby reducing, the damage of components such as a bumper during, offset collision of a vehicle and reducing costs required for repairing the vehicle.

### BACKGROUND OF THE INVENTION

In the related art, a back beam, which absorbs and reduces impact during head-on collision of a vehicle and improves the impact rigidity of the vehicle, is provided at the front portion of the vehicle and extends in a width direction of the vehicle.

FIG. 1 is a partial plan view of a back beam according to the related art. That is, a bumper 2 is provided at the front side of a back beam 1 that extends in a width direction of a vehicle and is gently curved toward the front side of the vehicle so as to have a predetermined curvature. Further, a front end module 3 on which a cooling module and the like are mounted is provided at the rear side of back beam 1.

Bumper 2 and front end module 3 extend to the left and right rounded corners of the vehicle, but back beam 1 does not extend to the rounded corners.

Accordingly, when head-on collision of a vehicle occurs the bumper is excessively deformed due to collision energy because bumper 2 is not sufficiently supported by the back beam. The excessive deformation of the bumper affects a hood and fenders, so that the hood, fenders, or lamps are excessively damaged. Accordingly, there is a problem in that a lot of costs are required for maintenance and repair of the vehicle.

Extension parts 1a, which extend from both distal end portions of the back beam to the left and right rounded corners of the vehicle as shown in FIG. 2, have been proposed to solve the above-mentioned problem in the related art. Each of extension parts 1a is gently curved toward the front side of the vehicle to have the same curvature as back beam 1.

However, when head-on offset collision occurs, a repulsive force of the back beam is generated in a direction perpendicular to the curvature of the extension part as shown by an arrow because each of extension parts 1a has a gentle curvature with respect to a collision direction of the vehicle. For this reason, a bumper supporting force of the back beam is decreased and thus the back beam cannot effectively support the bumper. Further, due to the substantially same curvatures of the back beam and the bumper, the bumper slides on the back beam as shown by an arrow. As a result, there is a problem in that the bumper is excessively damaged.

The information disclosed in this Background of the Invention section is only for enhancement of understanding of the background of the invention and should not be taken as an acknowledgement or any form of suggestion that this information forms the prior art that is already known to a person skilled in the art.

### SUMMARY OF THE INVENTION

Accordingly, the present invention has been made in an effort to solve the aforementioned problems associated with prior arts.

The back beam structure generates a repulsive force, which is generated at rounded corners of a vehicle, of a back beam against offset collision of the vehicle in a direction opposite to a collision direction, so that a supporting force of a bumper is improved. Further, the back beam structure allows the bumper not to slide on the back beam, so that it is possible to reduce the damage of the bumper and portions near the bumper. As a result, it is possible to reduce costs required for maintenance and repair of a vehicle.

According to an exemplary embodiment of the present invention, a back beam structure for a vehicle includes extension parts formed at both distal end portions of a back beam. The back beam extends in a width direction of a vehicle and then is gently curved toward the front side of the vehicle. The extension parts are curved toward the rear side of the vehicle and then extend straightly.

In the back beam structure for a vehicle according to an exemplary embodiment of the present invention, extension parts extending to the rounded corners of a vehicle generate a repulsive force in a direction opposite to a collision direction of a vehicle during the head-on offset collision so as to effectively support a bumper provided at the front side of the back beam and so as to allow the bumper not to slide on the back beam. For this reason, it is possible to significantly reduce the damage of the bumper, and to resist the rearward pushing of the bumper. As a result, it reduces the damage of a hood, fenders, or lamps, to reduce costs required for maintenance and repair of a vehicle, and to safely protect occupants.

The above features and advantages of the present invention will be apparent from or are set forth in more detail in the accompanying drawings, which are incorporated in and form a part of this specification, and the following Detailed Description of the Invention, which together serve to explain by way of example the principles of the present invention.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a partial plan view of a back beam according to the related art;

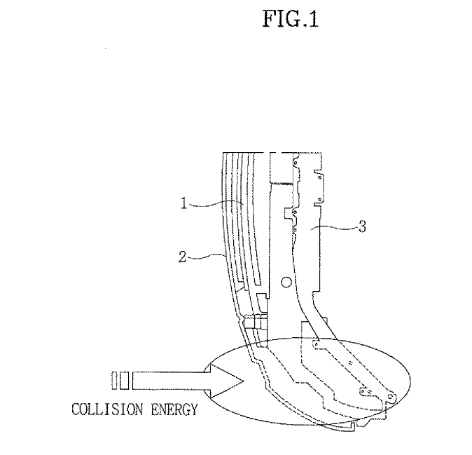

FIG. 2 is a partial plan view of the back beam according to another embodiment of the related art;

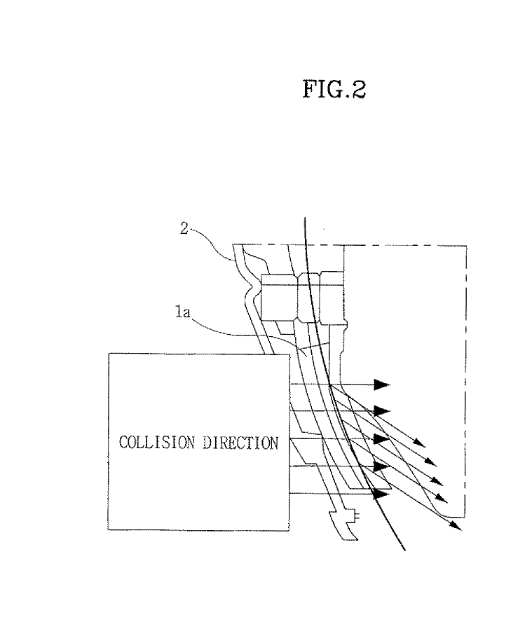

FIG. 3 is a partial perspective view of a back beam according to an exemplary embodiment of the present invention; and

FIG. 4 is a view illustrating the back beam according to an exemplary embodiment of the present invention when a collision occurs.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION OF THE PREFERRED EMBODIMENTS

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

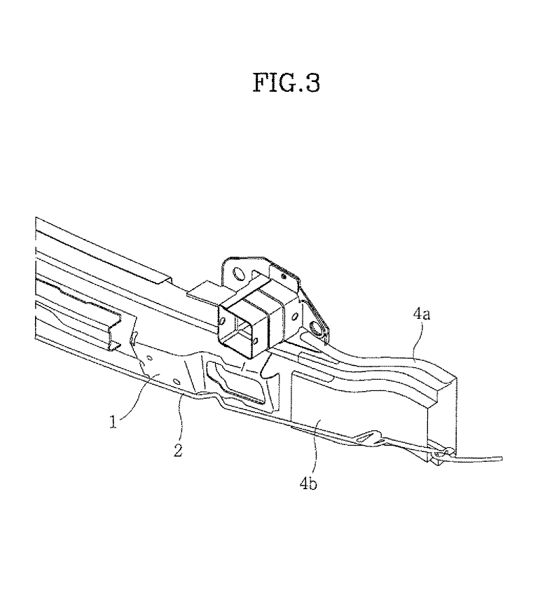

FIG. 3 is a partial perspective view of a back beam according to an exemplary embodiment of the present invention. That is, a back beam 1 extends in a width direction of a vehicle, and is curved toward the front side of the vehicle so as to have a gentle curvature.

Extension parts integrally extend from both distal end portions of back beam 1.

In an exemplary embodiment of the present invention, the extension parts comprise an inner extension part 4a and an outer extension part 4b that are integrally attached to each other. In another exemplary embodiment of the present invention, the inner and outer extension parts 4a and 4b may be integrally formed with the back beam. Alternatively, the inner and outer extension parts 4a and 4b may be separately formed and then integrally attached to each other.

The inner and outer extension parts 4a and 4b are curved toward the rear side of the vehicle so as to have a predetermined curvature respectively, and then extend straightly in a width direction of a vehicle. In another exemplary embodiment of the present invention, the inner and outer extension parts 4a and 4b may have the same predetermined curvatures. However, the directions of inner curvatures of the bumper and the extension parts are different.

A bumper 2, which absorbs impact during the collision, is provided on the front side of back beam 1.

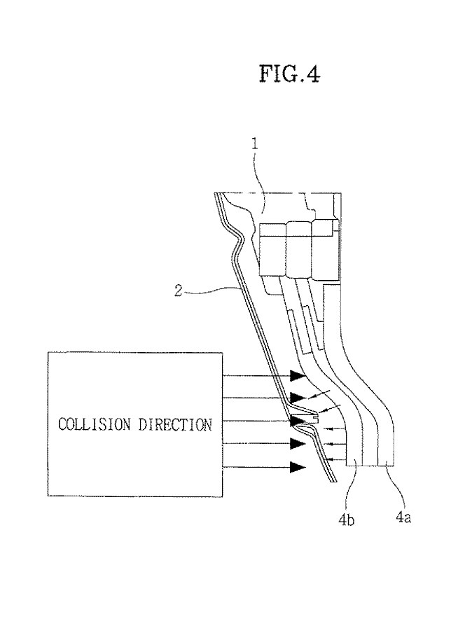

When head-on collision of a vehicle occurs, since the inner and outer extension parts 4a and 4b are formed as shown in FIG. 4, a repulsive force against the collision is generated in a direction opposite to the collision direction. This is because the extension parts curved toward the rear side of the vehicle functions like an elastic member having high stiffness.

Accordingly, the inner and outer extension parts are formed to effectively cope with the collision.

That is, when the bumper is pushed toward the rear side of the vehicle due to the head-on collision of a vehicle, the repulsive force of the outer and inner extension parts against the impact force is allowed to be generated in the direction opposite to the collision direction by the stiffness of the extension parts. For this reason, the impact force is absorbed, and the extension parts resist the collision. As a result, it is possible to prevent the bumper from being damaged and to prevent the bumper from being pushed rearward.

Furthermore, even though bumper is pushed rearward due to impact energy and then collides with the outer extension part, the bumper does not slide on the outer extension part since the directions of inner curvatures of the bumper and the outer extension part have the different directions to prevent the bumper from sliding on the outer extension part. As a result, it is possible to reduce the damage of the bumper as much as possible.

The forgoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiment were chosen and described in order to explain certain principles of the invention and their practical application, to thereby enable others skilled in the art to make and utilize various exemplary embodiments of the present invention, as well as various alternatives and modifications thereof. It is intended that technical spirit and scope of the present invention be defined by the Claims appended hereto and their equivalents.

What is claimed is:

1. A back beam structure for a vehicle, comprising:
a back beam that extends in a width direction of a vehicle and then is gently curved toward a front side of the vehicle;
at least an extension part formed at both distal end portions of the back beam wherein the directions of inner curvatures of the bumper and the extension parts are different.

2. The back beam structure as defined in claim 1, the extension parts are curved toward a rear side of the vehicle and then extending straightly in the width direction of the vehicle.

3. The back beam structure as defined in claim 1, wherein the extension parts include an outer extension pant, and an inner extension part attached to the distal end portions of the beam.

4. The back beam structure as defined in claim 3, wherein the inner and outer extension parts integrally extend from both distal end portions of the back beam.

5. The back beam structure as defined in claim 3, wherein the outer extension part and the inner extension part is separated each other.

6. The back beam structure as defined in claim 3, wherein the outer extension part and the inner extension part have a predetermined radius of curvature respectively,

7. The back beam structure as defined in claim 3, wherein the outer extension part and the inner extension part have same predetermined radius of curvature.
